(19) United States
(12) Patent Application Publication
(10) Pub. No.: US 2001/0036287 A1
(43) Pub. Date: Nov. 1, 2001

(54) Combination acoustical and electrical switch for a directional microphone

(76) Inventors: John J. Beard, Chicago, IL (US); John P. McSwiggen, Bloomingdale, IL (US); John R. Rodack JR., Lockport, IL (US)

Correspondence Address: WILLIAM J. LENZ, ESQ., WALLENSTEIN & WAGNER, LTD., 311 South Wacker, 53rd Floor, Chicago, IL, 60606-6622, US

(21) Appl. No.: 09/808,793

(22) Filed: Mar. 15, 2001

Related U.S. Application Data
(60) Provisional application No. 60/189,537, filed on Mar. 15, 2000.

(51) Int. Cl. H04R 25/00; H04R 17/02

(52) U.S. Cl. 381/313; 381/355

(57) ABSTRACT

A combination acoustical and electrical switch for a multi-port microphone in a hearing aid device that provides selectivity between a directional mode and an omnidirectional mode while also providing sensitivity adjustment for each of the modes. The switch includes a switch body having a port aperture therein in communication with one of the ports of the microphone, and a switch actuator moveably connected to the switch body and moveable to a first position wherein the port aperture is generally unobstructed by the actuator and a second position wherein the actuator covers the port aperture. The actuator is in communication with sensitivity optimization circuitry of the hearing aid to provide unidirectional sensitivity optimization in the first position and omnidirectional sensitivity optimization in the second position.

### RELATED APPLICATIONS

This application claims priority to Provisional Application Ser. No. 60/189,537, filed Mar. 15, 2000.

### TECHNICAL FIELD

The present invention generally relates to electromechanical switches for microelectronic devices, and more particularly to an acoustical and electrical switch for a directional microphone in a hearing aid.

### BACKGROUND OF THE INVENTION

Present hearing aid microphones are typically limited to being optimized for directional sensitivity or omnidirectional sensitivity to sounds that impinge upon the diaphragm of the microphone. The directivity of a microphone is the sensitivity of a microphone to a sound component at different angles of incidence. The microphone is typically optimized to be more sensitive to one component of the sound over the other. However, undesirable noise may occur within the hearing aid when a microphone that is optimized for a given directional component of an impinging sound receives higher levels of sound having other directional components.

Typical hearing aids either include a non-directional or directional hearing aid microphone system. An omnidirectional hearing aid system allows the user to pickup sounds from any direction. When a hearing aid user is trying to carry on a conversation within a crowded room, an omnidirectional hearing aid system does not allow the user to easily differentiate between the voice of the person the user is talking to and background or crowd noise. A directional hearing aid helps the user to hear the voice of the person they are having a conversation with, while reducing the miscellaneous crowd noise present within the room.

A hearing aid that provides selectivity between a directional and an omnidirectional mode will experience a change in sensitivity that is readily apparent when switching between modes. This change in sensitivity can be very uncomfortable to the hearing aid user.

Controllable directivity and sensitivity can help a wearer of a hearing aid to better understand a person speaking directly at the wearer while reducing the level of undesirable noise. Thus, there is a need for a hearing aid device having a microphone that can be electronically and acoustically optimized for both directional and omnidirectional sensitivity, depending upon the circumstances presented to the wearer of the hearing aid.

It is therefore an object of the present invention to provide a combination acoustical and electrical switch that provides selectivity between directional and omnidirectional modes of a microphone in a single hearing aid device.

It is also an object of the present invention to provide a combination acoustical and electrical switch that provides acoustical selectivity between directional and omnidirectional modes of a microphone while further providing electronic adjustment of sensitivity for the selected mode.

These and other objects will become readily apparent after reviewing the specification and drawings.

### SUMMARY OF THE INVENTION

A combination acoustical and electrical switch for a multi-port microphone in a hearing aid device that provides selectivity between a directional mode and an omnidirectional mode while also providing sensitivity adjustment for each of the modes. The switch includes a switch body having a port aperture therein in communication with one of the ports of the microphone, and a switch actuator moveably connected to the switch body and moveable to a first position wherein the port aperture is generally unobstructed by the actuator and a second position wherein the actuator covers the port aperture. The actuator is in communication with sensitivity optimization circuitry of the hearing aid to provide unidirectional sensitivity optimization in the first position and omnidirectional sensitivity optimization in the second position.

### BRIEF DESCRIPTION OF THE DRAWINGS

FIG. 1 is a cross-sectional side view of a first embodiment of a combination acoustical and electrical switch of the present invention showing the switch installed into a faceplate of a hearing aid device having a multi-port microphone.

FIG. 2 is a cross-sectional side view of the switch shown in FIG. 1.

FIG. 3 is a cross-sectional side view of a second embodiment of the present invention showing a rotary switch installed into a faceplate of a hearing aid device having a multi-port microphone.

FIG. 4 is a top plan view of a rotor of the rotary switch and the ports associated with the multi-port microphone shown in FIG. 3.

### DETAILED DESCRIPTION OF THE PREFERRED EMBODIMENTS

While the present invention will be described fully hereinafter with reference to the accompanying drawings, in which particular embodiments are shown, it is to be understood at the outset that persons skilled in the art may modify the invention herein described while still achieving the desired result of this invention. Accordingly, the description which follows is to be understood as a broad informative disclosure directed to persons skilled in the appropriate arts and not as limitations of the present invention.

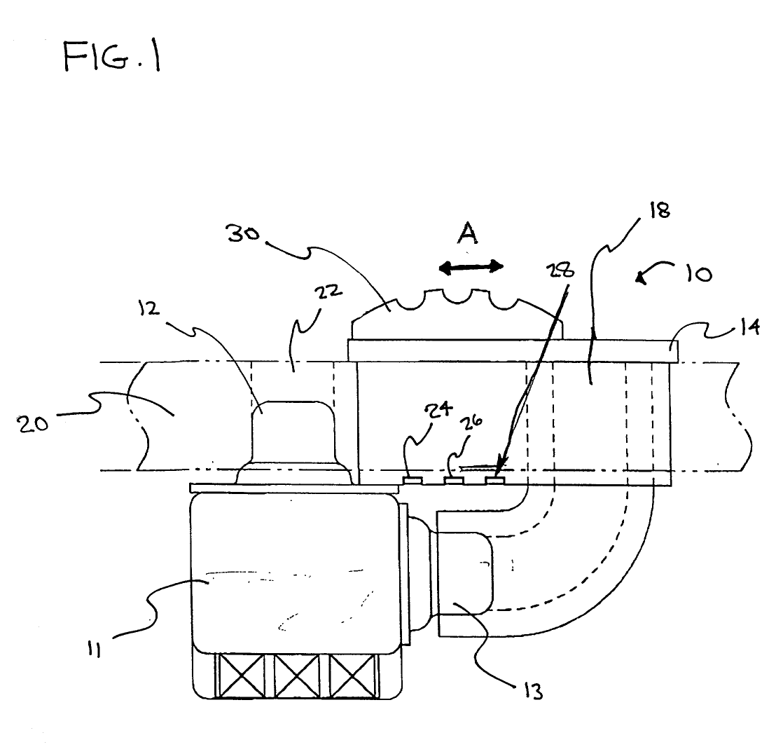

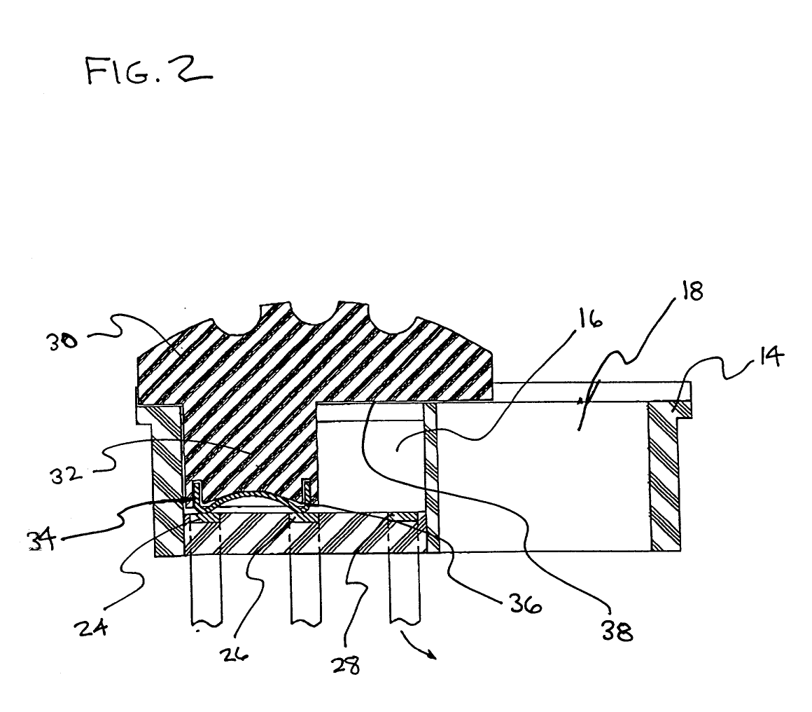

A combination acoustical and electrical switch 10 for a microphone 11 of a hearing aid device is shown in FIG. 1. The switch 10 provides increased sensitivity of the microphone 11 when the microphone 11 is in a directional mode and decreased sensitivity when the microphone 11 is in an omnidirectional mode. The microphone 11 has a front port 12 and a rear port 13. Referring to FIG. 2, the switch 10 includes a switch body 14 having a switch receptacle 16 and a port aperture 18 therein. As shown in FIG. 1, the switch 10 is installed within a faceplate 20 of the hearing aid such that the port aperture 18 of the switch 10 is in communication with the rear port 13 of the microphone 11. The front port 12 of the microphone is positioned in communication with an aperture 22 within the faceplate 20 to allow sound to pass therethrough. Electrical contacts 24, 26, and 28 are disposed within the switch receptacle 14. The contact 24 is electrically connected to electronic circuitry (not shown) that optimizes sensitivity of the microphone 11 for a directional acoustical mode. The contact 26 is connected to the common of the circuitry of the hearing aid. The contact 28 is electrically connected to electronic circuitry that optimizes sensitivity of the microphone 11 for an omnidirectional acoustical mode. The sensitivity of the microphone may be optimized through gain adjustment of the electrical signal produced by the microphone. In one embodiment, the circuitry for both modes may be a bias resistor electrically connected to other circuitry of the hearing aid to provide sensitivity adjustment. In another embodiment, the circuitry may provide selective connection with a bias resistor depending upon the particular mode selected. However, any means for adjusting the sensitivity of the microphone 11 that is well known in the art can be used.

A switch lever 30 having a contact extension 32 is positioned on the switch body 14 such that the contact extension 32 is slidably disposed within the switch receptacle 16. The switch slides in the directions indicated by arrows A in FIG. 1. A spring contact 34 is disposed on a bottom surface 36 of the contact extension 32 such that an electrical connection is established between the contacts 24 and 26 in a first position corresponding to the directional mode, and an electrical connection is established between the contacts 26 and 28 when the switch lever is slid to a second position corresponding to the omnidirectional mode. The switch lever 30 includes an aperture cover surface 38 that covers the port aperture 18 when the switch lever 30 is in the second position (omnidirectional mode). Thus, the rear port 13 of the microphone 11 is blocked in this position and does not allow sound to pass therethrough.

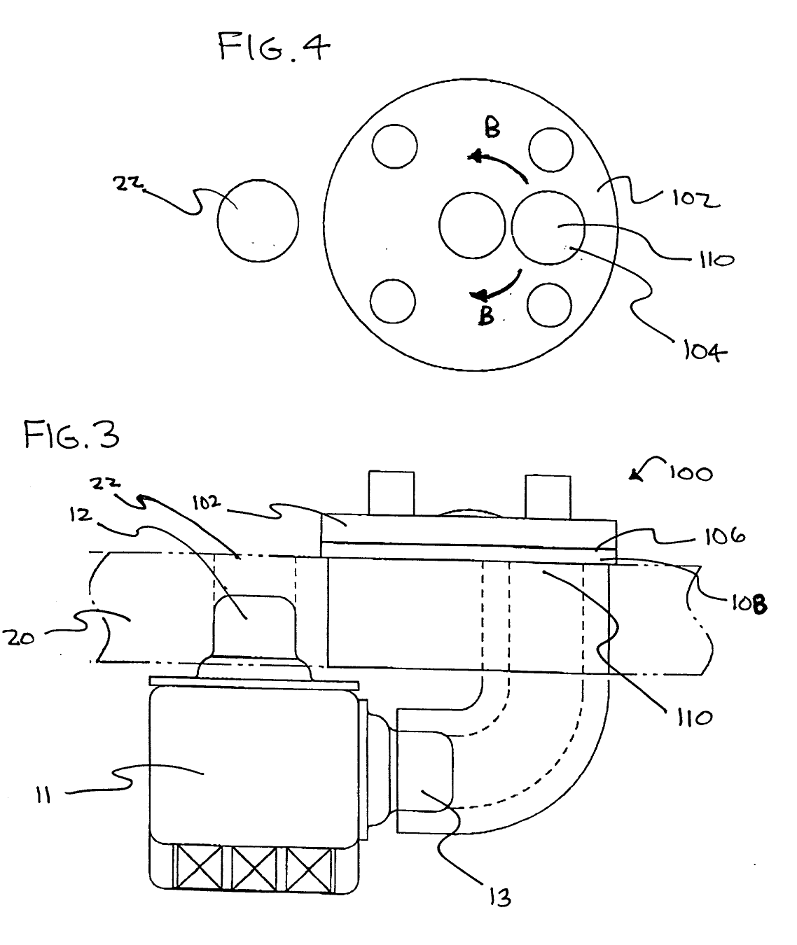

An alternate embodiment of the present invention is shown in FIGS. 3-4. For clarity of description, the same element numbers are used for elements that are common to both embodiments. In this embodiment, a switch 100 is provided with a rotor actuator 102 instead of the switch lever 30 of the first embodiment. The rotor actuator 102 is a common electrical switch that includes an aperture 104 therein. The rotor actuator 102 is disposed on a top surface 106 of a switch body 108 such that the rotor actuator 102 may be rotated between a first position and a second position. The rotor actuator rotates in the directions indicated by arrows B in FIG. 4. A detent (not shown) may be included to provide a tactile-type feel to a user to indicate that the rotor actuator 102 is in one of the two positions.

The switch body 108 includes a port aperture 110 in communication with the rear port 13 of the microphone 11. When the rotor actuator 102 is in the first position, the rotor aperture 104 is aligned with the port aperture 110 within the switch body 108. In the first position, the rotor actuator 102 establishes an electrical connection to circuitry for a directional mode that accordingly increases the sensitivity of the microphone 11. When the rotor actuator 102 is in the second position, the rotor actuator 102 covers the port aperture 110 within the switch body 108, thereby preventing sound from entering the rear port 13 of the microphone 11. In this omnidirectional second position, the rotor actuator 102 establishes an electrical connection to circuitry for an omnidirectional mode that accordingly decreases the sensitivity of the microphone 11. In all positions, the aperture 22 within the faceplate 20, which is in communication with the front port 12 of the microphone, remains unobstructed.

The combination acoustical and electrical switch of both embodiments provides selectivity of the acoustical mode of the microphone with simultaneous electrical adjustment of the sensitivity of the microphone for optimization corresponding to the particular acoustical mode selected. The switch of the present invention also provides this acoustical selectivity and electrical adjustment of sensitivity within a single component. These advantages are achieved while maintaining the size requirements imposed by hearing aids.

While the specific embodiments have been illustrated and described, numerous modifications may come to mind without significantly departing from the spirit of the invention, and the scope of protection is only limited by the scope of the accompanying claims.

What is claimed is:

1. A combination acoustical and electrical switch for a multi-port microphone in a hearing aid device having sensitivity optimization circuitry, the switch comprising:
a switch body having a port aperture therein, the port aperture in communication with one of the ports of the microphone; and
a switch actuator moveably connected to the switch body and moveable to a first position wherein the port aperture is generally unobstructed by the actuator and a second position wherein the actuator covers the port aperture, the actuator in communication with the sensitivity optimization circuitry of the hearing aid to provide unidirectional sensitivity optimization in the first position and omnidirectional sensitivity optimization in the second position.

2. The switch of claim 1, wherein the switch actuator provides selective connection to the sensitivity optimization circuitry of the hearing aid.

3. The switch of claim 1, wherein the switch actuator provides connection to the sensitivity optimization circuitry of the hearing aid in the first position.

4. The switch of claim 1, wherein the switch actuator provides connection to the sensitivity optimization circuitry of the hearing aid in the second position.

5. The switch of claim 1, wherein the switch actuator provides connection to the sensitivity optimization circuitry of the hearing aid in the first and second positions.

6. The switch of claim 1, wherein the switch body includes at least one electrical contact in electrical communication with the sensitivity optimization circuitry of the hearing aid.

7. The switch of claim 6, wherein the switch actuator includes at least one electrical contact that makes contact with the electrical contact of the switch body in one of the first and second positions.

8. The switch of claim 1, wherein the switch body includes three electrical contacts in electrical communication with the sensitivity optimization circuitry of the hearing aid and the switch actuator includes at least one electrical contact, the electrical contact of the switch actuator making contact with the first and second electrical contacts of the switch body in the first position, the electrical contact of the switch actuator making contact with the second and third electrical contacts of the switch body in the second position.

9. The switch of claim 1, wherein the switch actuator is a rotor actuator that is rotatably connected to the switch body.

10. The switch of claim 1, wherein the switch actuator is a switch lever that is slidably connected to the switch body.

11. A combination acoustical and electrical switch for a multi-port microphone in a hearing aid device having sensitivity optimization circuitry, the switch comprising:
a switch body having at least one electrical contact and a port aperture therein, the electrical contact in electrical communication with the sensitivity optimization circuitry of the hearing aid, the port aperture in communication with one of the ports of the microphone; and
a switch actuator moveably connected to the switch body, the actuator having at least one electrical contact and moveable to a first position and a second position, the electrical contact of the actuator making contact with the electrical contact of the switch body to cause sensitivity optimization for a unidirectional mode of the hearing aid in the first position, the port aperture being unobstructed by the actuator in the first position, the electrical contact of the actuator making contact with the electrical contact of the switch body to cause sensitivity optimization for an omnidirectional mode of the hearing aid in the second position, the actuator covering the port aperture in the second position.

12. The switch of claim 11, wherein the switch body includes three electrical contacts in electrical communication with the sensitivity optimization circuitry of the hearing aid, the electrical contact of the switch actuator making contact with the first and second electrical contacts of the switch body in the first position, the electrical contact of the switch actuator making contact with the second and third electrical contacts of the switch body in the second position.

13. The switch of claim 11, wherein the switch actuator is a rotor actuator that is rotatably connected to the switch body.

14. The switch of claim 11, wherein the switch actuator is a switch lever that is slidably connected to the switch body.

15. A combination acoustical and electrical switch for a multi-port microphone in a hearing aid device having sensitivity optimization circuitry, the switch comprising:
a switch body having a switch receptacle and a port aperture therein, the switch receptacle having electrical contacts in electrical communication with the sensitivity optimization circuitry of the hearing aid, the port aperture in communication with one of the ports of the microphone; and
a switch lever including an electrical contact, the switch lever slidably disposed within the receptacle of the switch body and slidable to a first position and a second position, the electrical contact of the switch lever electrically connecting two or more of the electrical contacts of the receptacle to cause sensitivity optimization for a unidirectional mode of the hearing aid in the first position, the port aperture being unobstructed by the switch lever in the first position, the electrical contact of the switch lever electrically connecting two or more of the electrical contacts of the receptacle to cause sensitivity optimization for an omnidirectional mode of the hearing aid in the second position, the switch lever covering the port aperture in the second position.

16. A combination acoustical and electrical switch for a multi-port microphone in a hearing aid device having sensitivity optimization circuitry, the switch comprising:
a switch body having at least one electrical contact and a port aperture therein, the electrical contacts in electrical communication with the sensitivity optimization circuitry of the hearing aid, the port aperture in communication with one of the ports of the microphone; and
a rotor actuator rotatably connected to the switch body and rotatable to a first position and a second position, the rotor actuator in communication with the sensitivity optimization circuitry and causing sensitivity optimization for a unidirectional mode of the hearing aid in the first position, the port aperture being unobstructed by the actuator in the first position, the rotor actuator causing sensitivity optimization for an omnidirectional mode of the hearing aid in the second position, the actuator covering the port aperture in the second position.
